(19) United States
(12) Patent Application Publication
(10) Pub. No.: US 2008/0238695 A1
(43) Pub. Date: Oct. 2, 2008

(54) Biological signal detector

(75) Inventors: Kenichi Yanai, Nisshin-city (JP); Shingo Imura, Kariya-city (JP); Shinji Nanba, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/076,971

(22) Filed: Mar. 26, 2008

(30) Foreign Application Priority Data
Mar. 26, 2007 (JP) 2007-79877

(51) Int. Cl. G08B 23/00

(52) U.S. Cl. 340/576

(57) ABSTRACT

A signal detector detects biological signal associated with a driver using electrode devices and a pulse wave sensor built into a steering wheel. A pulse wave sensor is built into a spoke part of the steering wheel and electrode devices are built into a ring part joined with the left and right spoke parts. The electrode devices and the pulse wave sensor are built into the surface of the steering wheel through insertion into recesses in the steering wheel. The left and right electrode devices and the pulse wave sensor contact thumb bases of the palms of the driver.

### CROSS REFERENCE TO RELATED APPLICATIONS

The present invention is based on and claims priority to Japanese Patent Application No. JP 2007-079877 filed on Mar. 26, 2007, and is related to the application entitled “BIOSIGNAL MEASURING EQUIPMENT” reference no. 111276-US based on Japanese Patent Application No. JP 2007-079878 filed on Mar. 26, 2007, the entire contents of all of which are incorporated herein by reference.

### BACKGROUND OF THE INVENTION

1. Field of the Invention

The present invention relates to a signal detector and more specifically, to a signal detector that obtains a biological signal associated with a driver of a vehicle using an electrode and other components provided on the steering wheel of the vehicle.

2. Description of the Related Art

Measuring instruments provided on the ring or spoke part of the steering wheel of a vehicle for measuring an electrocardiographic signal of a driver are known. Particularly, a pair of left and right electrode devices are positioned so that when the driver holds the steering wheel and thus the electrode devices, the potential difference between the electrode devices is detected to measure the electrocardiographic signals of the driver as described for example, in JP-A No. 2000-14653 and JP-A No. 2002-85360.

Also it has been proposed that, apart from an electrocardiographic signal measuring instrument provided in a vehicle, a pulse wave sensor for measuring a pulse wave of the driver is provided to estimate the blood pressure of the driver based on lags between measured electrocardiographic wave peaks and pulse wave peaks as described for example, in JP-A No. 2005-185608 and JP-A No. 2006-34803.

When a pulse wave sensor is mounted in a vehicle as mentioned above, the pulse wave sensor may be separate from the steering wheel, requiring the driver to put on a measuring device, which is inconvenient for the driver. Therefore, a pulse wave sensor built into the steering wheel, which, like electrode devices for measurement of electrocardiographic signals, the driver holds during driving, is more desirable.

When a pair of left and right electrode devices and a pulse wave sensor are built in the steering wheel as mentioned above, the pulse wave sensor should be placed on the right or left in the steering wheel so that the driver can touch it together with either electrode device while holding the steering wheel.

However, some areas of the palm have characteristics that make it difficult to measure pulse waves and electrocardiographic waves accurately. Even when an electrode device and a pulse wave sensor are located adjacent to each other in the steering wheel, there is a possibility that either the electrode device or the sensor touches, for example, a thick layer of the palm skin, making it difficult to obtain biological signals with stability.

### SUMMARY OF THE INVENTION

The present invention has been made in view of the above described disadvantages and an object thereof is to accurately detect biological signals alternatively referred to herein as biological signals, by arranging the electrode devices and a pulse wave sensor to be built into the steering wheel in a biological signal detector.

In order to achieve the above object, according to a first aspect, a biological signal detector includes a pair of left and right electrode devices and a pulse wave sensor provided on the front surface of grip portions of the steering wheel such as the surface facing the driver seat. The steering wheel is gripped by the driver and one of the electrode devices and the pulse wave sensor are located adjacent to each other within an area small enough to allow the driver to hold both of them with one hand at the same time.

In the steering wheel, the portions to be gripped by the driver, which can be referred to as the grip portions, are the ring and spoke parts. In particular, the base of the thumb touches the grip portions on the front surface of the steering wheel surface when gripped by the driver. The skin of the base of the thumb is the thinnest skin in the palm and is therefore the best region of the palm to acquire biological signals.

In accordance with various embodiments, the electrode devices and pulse wave sensor are advantageously located on the front surface of the steering wheel and one of the electrode devices and the pulse wave sensor are located adjacent to each other within an area small enough to allow the driver to hold both of them with one hand at a time, so that electrocardiographic waveform measurement by the use of the pair of left and right electrode devices and pulse wave measurement by the use of the pulse wave sensor are made simultaneously with high accuracy. It will be noted that various kinds of a biological signal such as electrocardiographic waveforms, pulse waves, blood pressures and the like can be measured simultaneously with high accuracy using the pair of left and right electrode devices and the pulse wave sensor in the above described manner. To accomplish measurement, the area of the steering wheel front surface within which the driver can touch with one hand at a time should be such that the maximum length of the area is 5 cm.

Since the steering wheel grip portions, such as the ring portion and spoke portion have complicated curved surfaces, the electrodes of the electrode device must also have complicated curved surfaces in order to install the pulse wave sensor compatibly in the spoke part and the electrode device in the ring part. It should be noted however that if the electrode device was required to be formed, for example, as a shape-compatible electrode plate and attached to the steering wheel, the manufacturing and assembly processes would be very troublesome.

Therefore, according to a second aspect, an electrode of each electrode device is formed on a base which can be buried in a recess made in the steering wheel and fixed in the steering wheel through the base. In such a case, the electrode of each electrode device is easily formed on the base separately from the steering wheel by plating or a similar process and easily built into the steering wheel by burying the base therein. Further, each of the left and right electrode devices may include one electrode or a plurality of electrodes.

Therefore, according to a third aspect, when the electrode device includes a plurality of electrodes, the electrodes are all formed on one base. By forming the electrodes in such a manner, the process of installing the electrode devices into the steering wheel is simplified and the electrodes of each electrode device can be easily placed in a limited area.

According to a fourth aspect, when the pulse wave sensor is an optical pulse wave sensor including a light emitting element and a light receiving element, the light emitting element and the light receiving element are integrally built in an electrode base of an electrode device located adjacent to the pulse wave sensor. In such a case, the pulse wave sensor and the electrode device can be more easily located adjacent to each other and the process of installing them into the steering wheel is more easily carried out.

According to a fifth aspect, one or more electrodes of the electrode device are located so as to surround the light emitting element and light receiving element of the pulse wave sensor in order to install the pulse wave sensor and the electrode device in a less curvy portion such as the spoke part of the front surface of the steering wheel.

In such a case, the electrode device and the pulse wave sensor can be installed in a small area more easily than when they are separately installed. In addition, the electrode device and the pulse wave sensor can be installed in a less curvy portion of the steering wheel such as the spoke part or the like. Therefore, the electrode device and pulse wave sensor can be more easily matched to the shape of the steering wheel, thereby making manufacture thereof simpler.

### BRIEF DESCRIPTION OF THE DRAWINGS

Other objects, features and characteristics of the present invention will be appreciated and become apparent to those of ordinary skill in the art and all of which form a part of the present application. In the drawings:

FIG. 1 is a block diagram illustrating the general structure of a biological signal detector according to an exemplary embodiment;

FIG. 2A is a diagram illustrating a front view of the steering wheel in an exemplary arrangement of components of the biological signal detector;

FIG. 2B is a diagram illustrating a sectional view of an exemplary arrangement of components of the biological signal detector in a vehicle taken along the line A-A of FIG. 2A;

FIG. 3A is a diagram illustrating a front view of an alternative installation of an exemplary right electrode device and a pulse wave sensor into the steering wheel; and

FIG. 3B is a diagram illustrating a sectional view of an alternative installation of an exemplary right electrode device and a pulse wave sensor into the steering wheel;

FIG. 4A is a diagram illustrating a front view of the steering wheel and an alternative arrangement of the electrodes of the right electrode device around a pulse wave sensor;

FIG. 4B is a diagram illustrating an alternative arrangement showing the right electrode device combined with the pulse wave sensor; and

FIG. 4C is a diagram illustrating a sectional view of an alternative arrangement of the electrodes of the right electrode device around a pulse wave sensor.

### DETAILED DESCRIPTION OF THE EXEMPLARY EMBODIMENTS

Next, exemplary embodiments of the present invention will be described in detail with reference to the accompanying drawings.

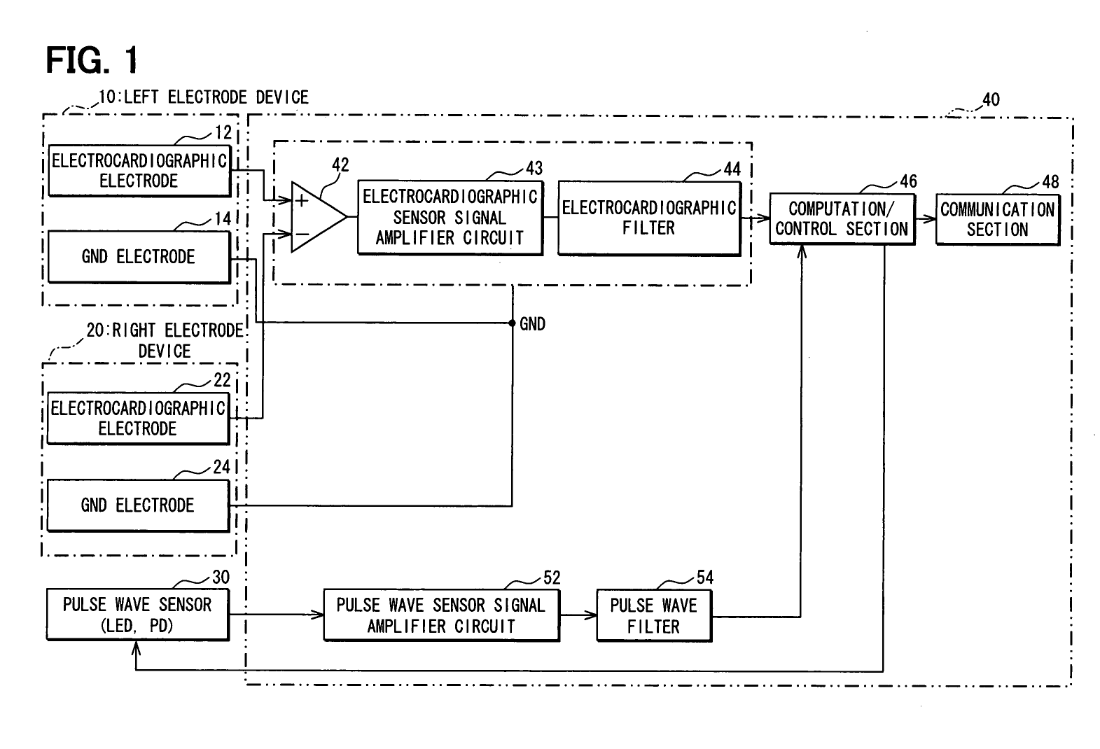

As shown in FIG. 1, the biological signal detector according to the present embodiment includes a pair of electrode devices including left electrode device 10 and right electrode device 20 for obtaining electrocardiographic signals from a vehicle driver and a pulse wave sensor 30 for obtaining pulse wave signals from the vehicle driver.

The left electrode devices 10 and right electrode devices 20 include an electrocardiographic electrode 12, an electrocardiographic electrode 22, a ground or reference (GND) electrode 14, and a GND electrode 24. The electrocardiographic electrodes 12 and 22 are connected respectively with the non-inverting input terminal (+) and inverting input terminal (−) of a differential amplifier circuit 42.

The differential amplifier circuit 42 outputs a signal that corresponds to a potential difference between signals generated by the electrocardiographic electrodes 12 and 22. The output signal is amplified by an electrocardiographic sensor signal amplifier circuit 43 and sent to a computation/control section 46 through an electrocardiographic filter 44 that permits the frequency component corresponding to the electrocardiographic waveform to pass through.

The GND electrodes 14 and 24, located adjacent to the electrocardiographic electrodes 12 and 22, are used to set the reference potential for signals obtained from the electrodes 12 and 22, which is set as ground potential GND in the present embodiment. The GND electrodes 14 and 24 are connected to the ground line of the differential amplifier circuit 42, electrocardiographic sensor signal amplifier circuit 43 and electrocardiographic filter 44.

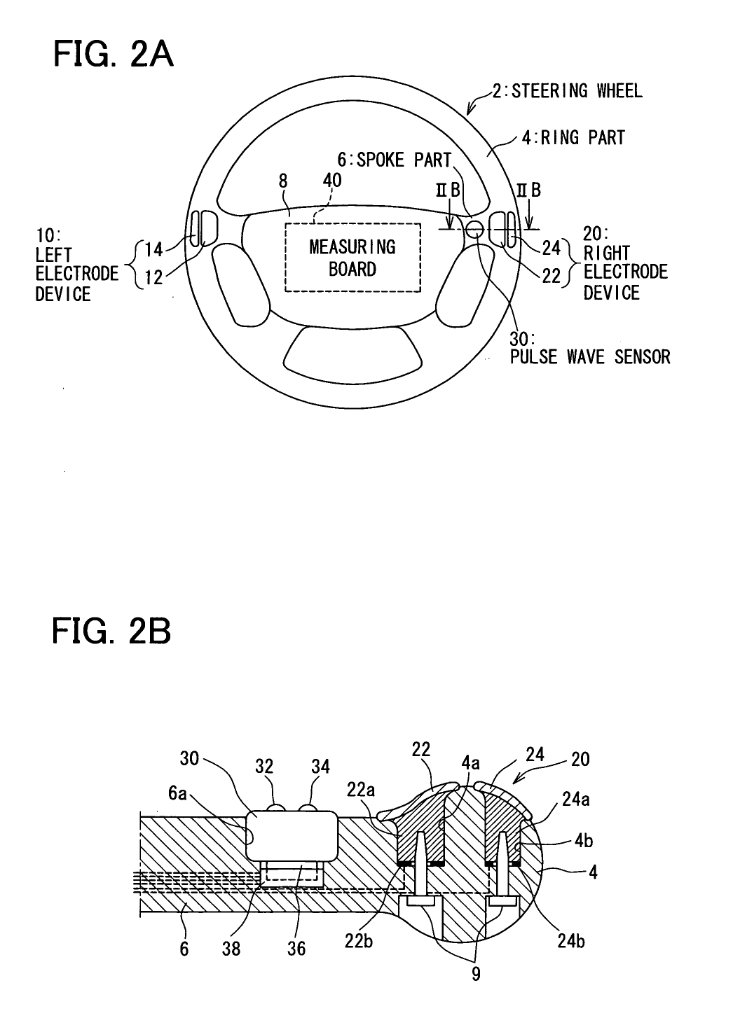

A pulse wave sensor 30 is a known optical pulse wave sensor which optically detects volume changes of blood vessels. It includes a light emitting diode (LED) 32, or other light emitting element, and a photo-diode (PD) 34, or other light receiving element as shown in FIG. 2B.

The LED 32 is activated by the computation/control section 46. As the LED 32 is activated, a light reception signal is generated from the PD 34 and amplified to a given level by a pulse wave sensor signal amplifier circuit 52 and then sent to the computation/control section 46 through a pulse wave filter 54.

The computation/control section 46, which is mainly composed of a microcomputer including a CPU, ROM, and RAM, takes measurements in the form of samples of electrocardiographic signals coming through the electrocardiographic filter 44 and pulse wave signals coming through the pulse wave filter 54 and stores the sample signals in the RAM or an external memory or analyzes the signals and performs various processes to calculate the blood pressure, heart rate and so on from the samples.

The computation/control section 46 is connected with a communication section 48 that sends the results of the calculations to a mobile device or a vehicle-mounted device with or without wires. The computation/control section 46 sends the result of measurement in response to a request from such an external device through the communication section 48.

As shown in FIG. 2A, the left electrode device 10, right electrode device 20 and pulse wave sensor 30, which are provided to acquire biological signals from the driver, are built into the ring part 4 and spoke part 6 of the steering wheel 2. It will be appreciated that the terms ring and spoke can refer to, for example, the circular portion of a wheel shape and the corresponding wheel spoke portion. Measuring circuits such as the differential amplifier circuit 42, electrocardiographic sensor signal amplifier circuit 43, electrocardiographic filter 44, computation/control section 46, communication section 48, pulse wave sensor signal amplifier circuit 52, and pulse wave filter 54 are formed on a measuring board 40 that is incorporated in the central part 8 of the steering wheel 2 where air bags or the like are typically placed.

The left electrode device 10, right electrode device 20 and pulse wave sensor 30 are installed in the steering wheel 2 as will be explained in detail. As shown in FIG. 2A, the left electrode device 10 and right electrode device 20 are located respectively on the left and right sides of the steering wheel 2 when in a standard position, that is with a steering angle of 0 degree as viewed from the driver seat side. The left electrode device 10 and right electrode device 20 are positioned in the vicinity of the left and right spoke parts 6 in a way to make contact when the driver grips the steering wheel 2 with both hands in a convenient position. The pulse wave sensor 30 is located, for example, on the right spoke part 6 as viewed from the driver seat side.

The left electrode device 10, right electrode device 20 and pulse wave sensor 30 are installed on the front surface of the steering wheel 2 in such a way that when the driver holds the steering wheel 2, contact is established with the bases of the thumbs of the driver in which the skin is thin and biological signals are easy to acquire.

The pulse wave sensor 30 and the electrocardiographic electrode 22 and GND electrode 24 of the right electrode device 20 are located such that the components come into line horizontally with the steering wheel 2 in its standard position. The components are further arranged such that when the driver holds the steering wheel 2, contact is established with, for example, the right palm of the driver and, in particular, the base of the thumb. More specifically, in order to acquire electrocardiographic signals and pulse wave signals at the same time, the distance between the left edge of the pulse wave sensor 30 and the right edge of the GND electrode 24 should be 5 cm or less.

As shown in FIG. 2B, the pulse wave sensor 30 includes the LED 32 and the PD 34, which are housed integrally in a case, and is fixed in place by inserting the case in a recess 6a made in the spoke part 6 of the steering wheel 2 to mount the pulse wave sensor 30.

The pulse wave sensor 30 also includes a connector 36 to connect the LED 32 and PD 34 to an external circuit and a connector 38 that connects the pulse wave sensor 30 with the measuring board 40 via a signal line inside the steering wheel 2 by engagement with the connector 36 provided in the recess 6a.

The electrocardiographic electrode 22 and GND electrode 24 of the right electrode device 20 are formed by making conductive layers on synthetic resin bases 22a and 24a, respectively, using a chemical or auto-catalytic plating process such as electroless plating or similar process. The bases 22a and 24a can be inserted into recesses 4a and 4b made in the ring part 4 of the steering wheel 2 respectively. The outer exposed surfaces of the bases buried in the recesses 4a and 4b are so curved as to match the shape of the ring part 4 or, in general can be curved to conform to a surface contour of the portion of the steering wheel in which they are installed. The bases 22a and 24a are fixed in the recesses 4a and 4b of the ring part 4 with fixing screws 9 inserted from behind the ring part 4.

Terminals 22b and 24b are electrically connected with the conductive layers formed on the outer surface, namely the electrocardiographic electrode 22 and GND electrode 24, and are formed on the bottom faces of the bases 22a and 24a, respectively. Also, electrodes connected with the signal line inside the steering wheel are provided in the recesses 4a and 4b to connect the electrocardiographic electrode 22 and GND electrode 24 to the measuring board 40. Therefore, when installing the electrocardiographic electrode 22 and GND electrode 24 of the right electrode device 20 in the steering wheel 2, the electrodes 22 and 24 are securely connected with the measuring board 40 by tightening the fixing screws 9 firmly.

The electrocardiographic electrode 12 and GND electrode 14 of the left electrode device 10 are arranged on the left on the ring part 4 of the steering wheel 2 so that they are symmetrical to the electrocardiographic electrode 22 and GND electrode 24 of the right electrode device 20. The structure and manner of installation in the steering wheel 2 is the same as for the right electrode device 20 and therefore a detailed description thereof is omitted for simplicity.

As described above, in the biological signal detector according to the present embodiment, the left and right electrode devices 10, 20 and the pulse wave sensor 30 are located on the front surface of the steering wheel 2 where the pulse wave sensor 30 and the right electrode device 20 are built into the right spoke part 6 of the steering wheel 2 in the vicinity of the ring part 4 outside the right spoke part 6.

Therefore, according to the present embodiment, the left and right electrode devices 10, 20 and the pulse wave sensor 30 can more easily come into contact with the base of the thumb region of the palm of the driver where acquiring electrocardiographic signals and pulse wave signals is easier. Hence, according to the present embodiment, various types of a biological signal such as electrocardiographic waveforms, pulse waves, blood pressures, and heart rates can be measured accurately through these components.

Since the electrodes 22 and 24 of the right electrode device 20 are formed by plating on the bases 22a and 24b, which can be inserted and fixed in the recesses 4a and 4b of the ring part 4 of the steering wheel 2 as described, the shape of the electrodes 22 and 24 can be easily matched to the curved surface of the ring part 4. Furthermore, the process of installing the electrodes is simplified: the electrodes are installed in the steering wheel 2 only by inserting the bases 22a and 24a into the recesses 4a and 4b and tightening the fixing screws 9 from behind the ring part 4 respectively. Since the electrodes 12 and 14 of the left electrode device 10 have the same structure as those of the right electrode device 20, they offer the same advantageous effect as mentioned above.

An embodiment of the present invention has been so far explained. However, the invention is not limited thereto but may be embodied in other various forms without departing from the spirit and scope thereof.

For example, in the above embodiment, the left electrode device 10 and the right electrode device 20 include the electrocardiographic electrode 12, the electrocardiographic electrode 22, the GND electrode 14, and the GND electrode 24 which are separate from each other. However, it is also possible to form the electrocardiographic electrode 12, the electrocardiographic electrode 22, the GND electrode 14 and the GND electrode 24 integrally on a common base and install them in the steering wheel 2 through the base.

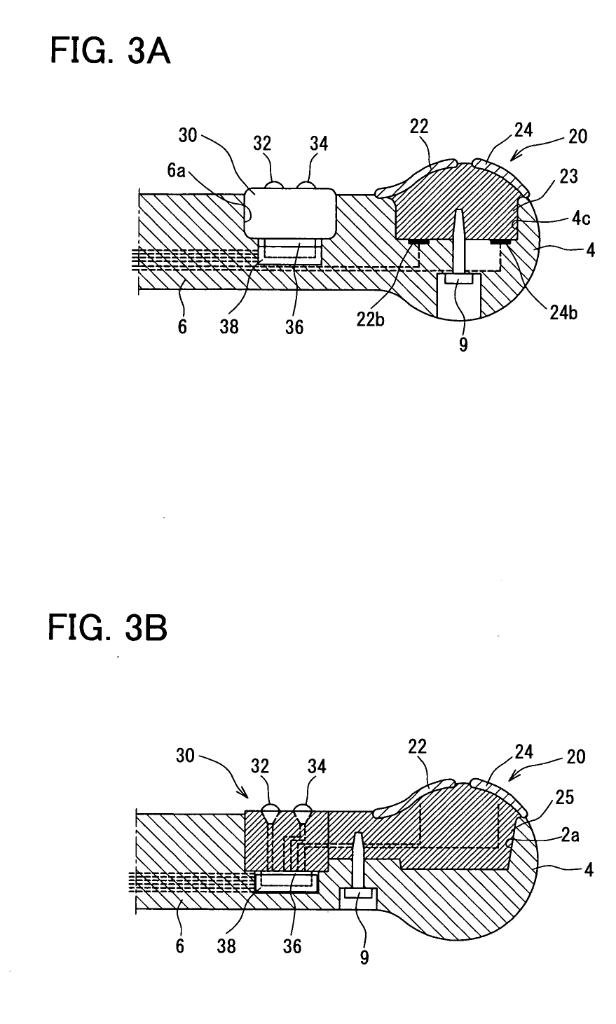

FIG. 3A illustrates that the electrocardiographic electrode 22 and GND electrode 24 of the right electrode device 20 are both formed on a base 23 which can be inserted in a recess 4c made in the ring part 4. The base 23 is fixed in the recess 4c by a fixing screw 9.

The left and right electrode devices 10 and 20, structured in the above described manner, can be installed in the steering wheel 2 more easily. Further, the electrode device 10, the electrode device 20, the electrodes 12 and 14 and the electrodes 22 and 24 can be closer to each other thus increasing the probability of establishing solid contact with the thumb portions of the driver.

In the above embodiment, the pulse wave sensor 30 is a separate device with LED 32 and PD 34 housed in the case. However, as shown in FIG. 3B, it is also possible that a base 25, on which the electrocardiographic electrode 22 and GND electrode 24 of the right electrode device 20 adjacent to the pulse wave sensor are integrally formed 30, is extended to the area in which the pulse wave sensor 30 lies. The LED 32 and PD 34 of the pulse wave sensor 30 are built in the base 25 so that the right electrode device 20 and the pulse wave sensor 30 can be simultaneously installed in the steering wheel 2 leading to manufacturing simplicity.

However, since the base 25 stretches from the area of the right electrode device 20 to the area of the pulse wave sensor 30, it is necessary to make a recess 2a that is large enough to embrace the base 25 and stretches from the steering wheel ring part 4 to the right spoke part 6. In such a case, as illustrated in FIG. 3B, a connector 36 may be provided on the bottom of the base 25 in order to connect the electrocardiographic electrode 22, the GND electrode 24, the LED 32 and the PD 34 with the measuring board 40, to engage with a connector 38 in the recess 2a. Alternatively, an electrode connected with the above described components may be formed on the bottom of the base 25. In either case, the base 25 is relatively large and should be fixed firmly with a fixing screw 9.

In the above described embodiments, the components are built in portions of the steering wheel 2 which the driver is likely to grip, according to the following exemplary descriptions. For example, the pulse wave sensor 30, electrocardiographic electrode 22 and GND electrode 24 are arranged in line in an area from the right spoke part 6 to the ring part 4 as viewed from the driver seat. The electrocardiographic electrode 12 and GND electrode 14 lie side by side horizontally in the ring part 4 which is continuous with the left spoke 6. However the invention is not limited thereto and the arrangement of these components should be determined depending on the design of the steering wheel 2 or other factors as appropriate.

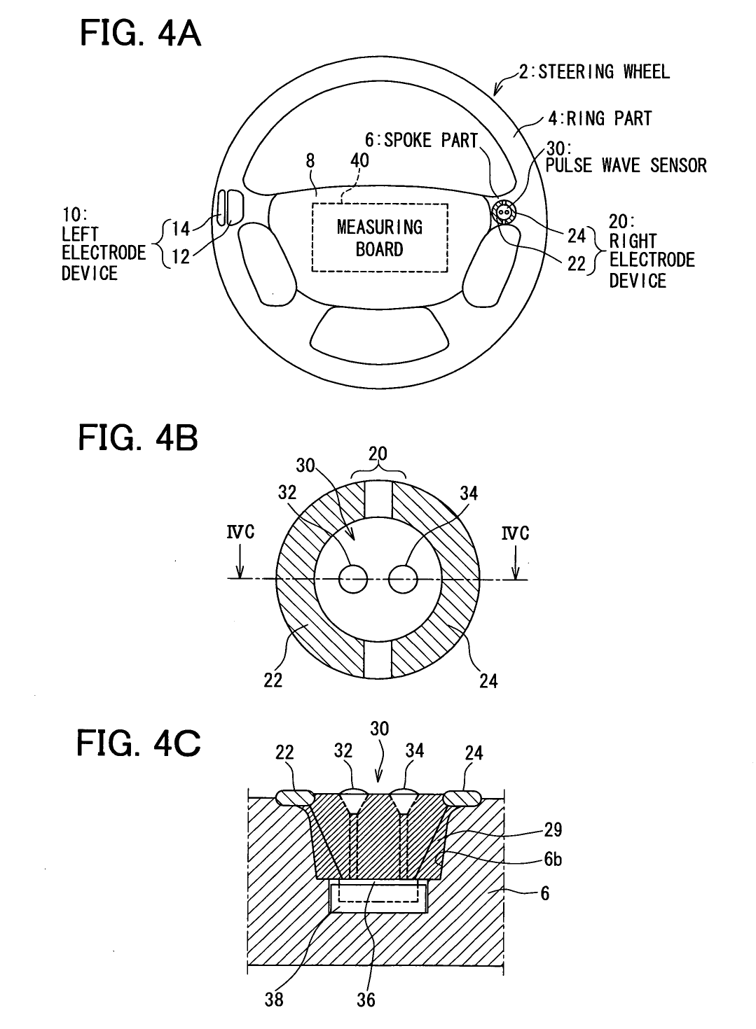

An alternative arrangement of the right electrode device 20 that is located adjacent to the pulse wave sensor 30 can be as follows. As illustrated in FIG. 4A, FIG. 4B and FIG. 4C, the electrocardiographic electrode 22 and GND electrode 24 are located so as to surround the pulse wave sensor 30, specifically, LED 32 and PD 34 thereof. In such an arrangement, the sensing members are combined in a compact manner simplifying the process of installation into the steering wheel 2.

FIG. 4A is a front view of the steering wheel as viewed from the driver seat. FIG. 4B shows an assembly combining the right electrode device 20 and the pulse wave sensor 30 in enlarged form as viewed from the driver seat. FIG. 4C is a sectional view taken along the line B-B of FIG. 4B.

In the exemplary cases shown in FIG. 4A, 4B, and 4C, the pulse wave sensor 30 and right electrode device 20 are combined as follows. As illustrated in FIG. 4B and FIG. 4C, an electrocardiographic electrode 22 and a GND electrode 24 are formed on the peripheral area of the upper surface of a virtually cylindrical base 29 of synthetic resin using a chemical or auto-catalytic plating process such as electroless plating or a similar process in a manner so as to bisect the peripheral area. The LED 32 and PD 34 that constitute the pulse wave sensor 30 are fixed in the central area of the upper surface of the base 29 where the a connector 36 connected with these components via a signal line is fixed on the bottom of the base 29.

In the above described arrangement, as illustrated in FIG. 4A and FIG. 4C, the pulse wave sensor 30 and right electrode device 20 can be built in the spoke part 6 adjacent to the ring part in a stable manner 4 by inserting the assembly in a recess 6b in the spoke 6 of the steering wheel 2. In addition, the assembly where the electrode device 20 and pulse wave sensor 30 are combined can be compact and is therefore more easily installed into the steering wheel 2. The above described assembly can also be built in the ring part 4 when the upper surface of the base is shaped to match the curved surface of the ring part 4.

Also in the above embodiment, the pulse wave sensor 30 is built in the right grip portion of the steering wheel 2 adjacent to the right electrode device 20. However, it will be appreciated that the pulse wave sensor 30 may alternatively be built in the left grip portion of the steering wheel 2 adjacent to the left electrode device 10. Further, the left electrode device 10 includes an electrocardiographic electrode 12 and a GND electrode 14 and the right electrode device 20 includes an electrocardiographic electrode 22 and a GND electrode 24. However, it should be noted that the GND electrodes 14 and 24 are generally not interchangeable and only the electrode device 10 may have the GND electrode 14 and the electrode device 20 may have the GND electrode 24.

Still further in the above embodiment, the left and right electrode devices 10 and 20 use the differential amplifier circuit 42, electrocardiographic sensor signal amplifier circuit 43, and electrocardiographic filter 44 to measure electrocardiographic waves. Alternatively, an impedance measuring circuit may be provided on the measuring board 40 so that the circuit to which the electrocardiographic electrodes 12 and 22 of the left and right electrode devices 10 and 20 are connected can be changed from the differential amplifier circuit 42 to the impedance measuring circuit using a switch or something like that in order to measure the driver's biological impedance.

What is claimed is:

1. A biological signal detector to obtain a biological signal associated with a driver of a vehicle, the biological signal detector comprising:
a left electrode device and a right electrode device provided respectively on each of a left grip portion and a right grip portions of a steering wheel capable of being touched by a left and a right hand of the driver; and
a pulse wave sensor measuring a pulse wave of a driver,
wherein:
the left electrode device and the right electrode device and the pulse wave sensor are located on a front surface of the steering wheel facing a driver seat; and
one of the left electrode device and the right electrode device and the pulse wave sensor are located adjacent to each other within an area sufficiently small enough to allow both the one and the pulse wave sensor to be gripped by a driver with one hand at the same time.

2. The biological signal detector according to claim 1, wherein each of the left electrode device and the right electrode device includes one or more electrodes and the one or more electrodes are formed on an electrode base that is formed to be inserted in a recess in the steering wheel.

3. The biological signal detector according to claim 1, wherein each of the left electrode device and the right electrode device includes a plurality of electrodes and the plural electrodes are formed on a single base which can be buried in a recess in the steering wheel.

4. The biological signal detector according to claim 2, wherein:
the pulse wave sensor includes an optical pulse wave sensor having a light emitting element and a light receiving element; and
the light emitting element and the light receiving element are built in the electrode base of the one of the left electrode device and right electrode device that is located adjacent to the pulse wave sensor.

5. The biological signal detector according to claim 1, wherein:
the pulse wave sensor includes an optical pulse wave sensor including a light emitting element and a light receiving element; and
the one of the left electrode device and the right electrode device located adjacent to the pulse wave sensor includes one or more electrodes located so as to surround the light emitting element and the light receiving element.

6. A signal detector included in a steering wheel of a vehicle, the signal detector for obtaining a biological signal associated with a driver of the vehicle, the signal detector comprising:
a left electrode device and a right electrode device provided respectively on each of a left grip portion and a right grip portions of a steering wheel of the vehicle, the steering wheel capable of being touched by a left and a right hand of the driver; and
a pulse sensor configured to measure a pulse of a driver,
wherein one of the left electrode device and the right electrode device and the pulse wave sensor are located adjacent to each other within an area having a high probability of being gripped by the driver, the area sufficiently small enough to allow both the one and the pulse wave sensor to be gripped by a driver with one hand at the same time.

7. The signal detector according to claim 6, wherein a maximum length of the area is approximately 5 cm.

8. The signal detector according to claim 6, wherein each of the left electrode device and the right electrode device includes one or more electrodes capable of measuring the biological signal, the one or more electrodes including a first portion curved to conform to a surface contour of the steering wheel and a second portion formed as a flat bottom electrode base to be inserted into a recess in the steering wheel, the recess having a flat bottom receiving portion.

9. The signal detector according to claim 8, wherein the second portion of the one or more electrodes include a synthetic resin base and wherein the first curved portion includes a conductive layer formed on the synthetic resin base.

10. The signal detector according to claim 8, further comprising a measuring board located in the steering wheel, wherein the second portion of the one or more electrodes include a synthetic resin base, wherein the first curved portion includes a conductive layer formed on the synthetic resin base and wherein a connector is provided on the synthetic resin base, the connector for electrically connecting the conductive layer and the measuring board.

11. The signal detector according to claim 6, wherein each of the left electrode device and the right electrode device includes a plurality of electrodes formed on a single flat bottom base portion to be inserted in a recess in the steering wheel, the recess having a flat bottom receiving portion, the plurality of electrodes each having a contact surface curved to conform to a surface contour of the steering wheel.

12. The signal detector according to claim 8, wherein:
the pulse sensor includes an optical pulse wave sensor having a light emitting element and a light receiving element; and
the light emitting element and the light receiving element are built into the second portion of the one of the left electrode device and right electrode device that is located adjacent to the pulse wave sensor.

13. The signal detector according to claim 6, wherein:
the pulse sensor includes an optical pulse wave sensor including a light emitting element and a light receiving element; and
the one of the left electrode device and the right electrode device located adjacent to the pulse wave sensor includes one or more electrodes located so as to surround the light emitting element and the light receiving element.
